(19) United States
(12) Patent Application Publication
(10) Pub. No.: US 2026/0175128 A1
(43) Pub. Date: Jun. 25, 2026

(54) ONE OR MORE NON-TRANSITORY COMPUTER-READABLE STORAGE MEDIA, INFORMATION PROCESSING SYSTEM, AND COMPUTER-IMPLEMENTED METHOD

(71) Applicant: Nintendo Co., Ltd., Kyoto (JP)

(72) Inventor: Jyunya OSADA, Kyoto (JP)

(21) Appl. No.: 19/410,998

(22) Filed: Dec. 5, 2025

(30) Foreign Application Priority Data
Dec. 25, 2024 (JP) 2024-228627

(51) Int. Cl. A63F 13/54; A63F 13/424; A63F 13/525; A63F 13/56

(52) U.S. Cl. CPC A63F 13/54; A63F 13/424; A63F 13/525; A63F 13/56

(57) ABSTRACT

In an example of an information processing system according to an exemplary embodiment, a sound source and a virtual listener are set in a virtual space, an attenuation reference distance obtained by correcting a distance between a position of the virtual listener and a position of the sound source so that the greater a velocity at which the sound source goes away from the virtual listener is, the closer to the virtual listener the sound source is calculated, and distance attenuation of the sound volume of the sound source is calculated based on the calculated attenuation reference distance.

### CROSS REFERENCE TO RELATED APPLICATION

This application claims priority to Japanese Patent Application No. 2024-228627 filed on Dec. 25, 2024, the entire contents of which are incorporated herein by reference.

### FIELD

An exemplary embodiment relates to one or more non-transitory computer-readable storage media having stored therein an information processing program, an information processing system, an information processing apparatus, and a computer-implemented method that are capable of controlling audio.

### BACKGROUND AND SUMMARY

Conventionally, there is an information processing program for attenuating the sound volume of a sound source in a virtual space based on a distance.

In the above conventional method, there is room for improvement in leaving the presence of the sound source in a case where the sound source goes away.

The exemplary embodiment discloses an information processing program, an information processing system, an information processing apparatus, and a computer-implemented method that are capable of, in a case where a sound source goes away, leaving the presence of a sound source to some extent.

### First Configuration

A first configuration of the exemplary embodiment is one or more non-transitory computer-readable storage media having stored therein instructions that, when executed, cause one or more processors to perform operations including: regarding each of at least one sound source set in a virtual space, based on an attenuation reference distance obtained by correcting a distance between a position of a virtual listener and a position of the sound source in the virtual space so that the greater a velocity at which the sound source goes away from the virtual listener is, the closer to the virtual listener the sound source is. The operations include, based on distance attenuation according to the attenuation reference distance, determining a sound volume of audio set for the sound source. The operations include, based on the determined sound volume, outputting the audio set for the sound source.

Based on the above, for example, even if a sound source goes away, it is possible to leave the presence of the sound source to some extent.

### Second Configuration

According to second configuration, in the above first configuration, the velocity at which the sound source goes away from the virtual listener may be a value based on a component in a direction from the sound source to the virtual listener or a component in a direction from the virtual listener to the sound source of a relative velocity between the sound source and the virtual listener.

Based on the above, based on a component in a direction from the sound source to a virtual listener or a component in a direction from the virtual listener to the sound source of a relative velocity between the sound source and the virtual listener, it is possible to obtain a velocity at which the sound source goes away from the virtual listener.

### Third Configuration

According to a third configuration, in the above first or second configuration, the operations may further include making the correction so that the greater the distance between the position of the virtual listener and the position of the sound source in the virtual space is, the smaller the correction is.

Based on the above, it is possible to make correction so that the greater the distance between the virtual listener and the sound source is, the smaller the correction is. Thus, for example, it is possible to prevent a sound that should not be heard because the sound source is too far from being heard.

### Fourth Configuration

According to a fourth configuration, in any of the above first to third configurations, the virtual listener may be set at a position according to a position of a virtual camera in the virtual space.

Based on the above, in a case where the sound source viewed from a virtual camera goes away, it is possible to attenuate the sound volume of the sound source based on an attenuation reference distance.

### Fifth Configuration

According to a fifth configuration, in the above fourth configuration, the operations may further include: performing movement control of a player object in the virtual space based on an operation input; and performing movement control of the position of the virtual camera so that the position of the virtual camera is a position according to a position of the player object.

Based on the above, in a case where a player object is subjected to movement control with the virtual camera, and if the sound source goes away, it is possible to attenuate the sound volume of the sound source based on the attenuation reference distance.

### Sixth Configuration

According to a sixth configuration, in the above fifth configuration, the player object may be a running object that runs on a field in the virtual space. The sound source may be at least set at a position of the running object other than the player object in the virtual space. The operations may further include causing the player object and the running object other than the player object to run on the field.

Based on the above, for example, in a game where an object is caused to run, such as a racing game or the like, and in a case where a running object goes away from a player object by passing, overtaking, or the like, it is possible to leave the sound from the running object to some extent.

Another configuration may be an information processing system, or may be an information processing apparatus, or may be a computer-implemented method.

According to an example of the exemplary embodiment, for example, in a case where a sound source goes away at high speed, it is possible to leave the presence of the sound source to some extent.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of a game system;

FIG. 2 is an example non-limiting block diagram showing an example of the internal configuration of a main body apparatus;

FIG. 3 is an example non-limiting diagram of a virtual space during a racing game when viewed from above;

FIG. 4 is an example non-limiting diagram illustrating a method for calculating an attenuation reference distance;

FIG. 5 is an example non-limiting diagram illustrating distance attenuation based on the attenuation reference distance CD calculated by formula (5);

FIG. 6 is an example non-limiting diagram of the virtual space during the racing game when viewed from above and is an example non-limiting diagram showing an example of the virtual space in a case where a plurality of sound source objects exist;

FIG. 7 is an example non-limiting diagram showing examples of various pieces of data stored in the game system 1;

FIG. 8 is an example non-limiting flow chart showing an example of game processing regarding the racing game; and

FIG. 9 is an example non-limiting flow chart showing the details of an audio control process in step S15;

### DETAILED DESCRIPTION OF NON-LIMITING EXAMPLE EMBODIMENTS

### Game System Configuration

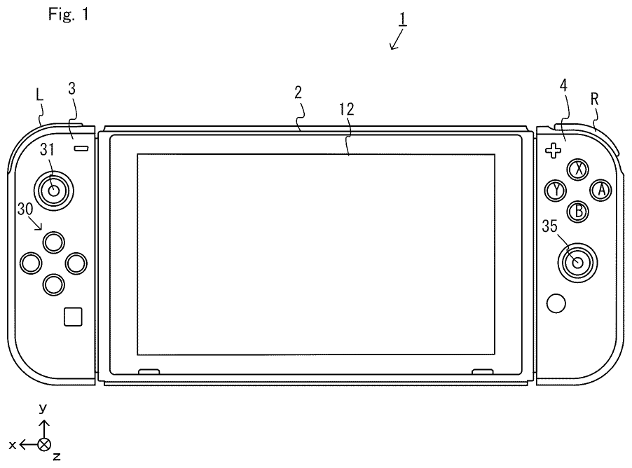

A game system according to an example of an exemplary embodiment is described below. FIG. 1 is a diagram showing an exemplary game system. An example of a game system 1 according to the exemplary embodiment includes a main body apparatus (an information processing apparatus; which functions as a game apparatus main body in the exemplary embodiment) 2, a left controller 3, and a right controller 4. The main body apparatus 2 is an apparatus for performing various processes (e.g., game processing) in the game system 1. The left controller 3 and the right controller 4 each include a plurality of direction buttons 30 including an up button, a down button, a right button, and a left button, a plurality of buttons (an A-button, a B-button, an X-button, a Y-button, an L-button, an R-button, and the like), a left analog stick 31, and a right analog stick 35 as exemplary operation units through which a user performs input.

Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2, or the main body apparatus 2, the left controller 3, and the right controller 4 may be separated from one another, when being used. It should be noted that hereinafter, the left controller 3 and the right controller 4 will occasionally be referred to collectively as a “controller”.

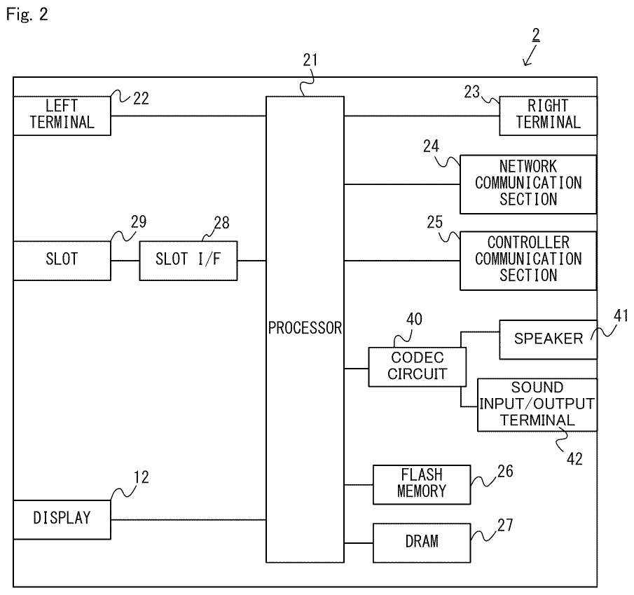

FIG. 2 is a block diagram showing an example of the internal configuration of the main body apparatus 2. As shown in FIG. 2, the main body apparatus 2 includes a processor 21. The processor 21 is an information processing section for executing various types of information processing (e.g., game processing) to be executed by the main body apparatus 2, and for example, includes one of more CPUs (Central Processing Units) and one of more GPUs (Graphics Processing Units). Note that the processor 21 may be configured only by a CPU, or may be configured by a SoC (System-on-a-Chip) that includes a plurality of functions such as a CPU function and a GPU function. The processor 21 executes an information processing program (e.g., a game program) stored in a storage section (specifically, an internal storage medium such as a flash memory 26, an external storage medium attached to the slot 29, or the like), thereby performing the various types of information processing.

Further, the main body apparatus 2 also includes a display 12. The display 12 displays an image generated by the main body apparatus 2. In the exemplary embodiment, the display 12 is a liquid crystal display device (LCD). The display 12, however, may be a display device of any type. The display 12 is connected to the processor 21. The processor 21 displays a generated image (e.g., an image generated by executing the above information processing) and/or an externally acquired image on the display 12.

Further, the main body apparatus 2 includes a left terminal 22, which is a terminal for the main body apparatus 2 to perform wired communication with the left controller 3, and a right terminal 23, which is a terminal for the main body apparatus 2 to perform wired communication with the right controller 4.

Further, the main body apparatus 2 includes a flash memory 26 and a DRAM (Dynamic Random Access Memory) 27 as examples of internal storage media built into the main body apparatus 2. The flash memory 26 and the DRAM 27 are connected to the processor 21. The flash memory 26 is a memory mainly used to store various data (or programs) to be saved in the main body apparatus 2. The DRAM 27 is a memory used to temporarily store various data used for information processing.

The main body apparatus 2 includes a slot 29. The slot 29 is so shaped as to allow a predetermined type of storage medium to be attached to the slot 29. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of a game application or the like) used by the main body apparatus 2 and/or a program (e.g., a game program or the like) executed by the main body apparatus 2.

The main body apparatus 2 includes a slot interface (hereinafter abbreviated as “I/F”) 28. The slot I/F 28 is connected to the processor 21. The slot I/F 28 is connected to the slot 29, and in accordance with an instruction from the processor 21, reads and writes data from and to the predetermined type of storage medium (e.g., a dedicated memory card) attached to the slot 29.

The processor 21 appropriately reads and writes data from and to the flash memory 26, the DRAM 27, and each of the above storage media, thereby performing the above information processing.

The main body apparatus 2 includes a network communication section 24. The network communication section 24 is connected to the processor 21. The network communication section 24 performs wired or wireless communication with an external apparatus via a network. In the exemplary embodiment, as a first communication form, the network communication section 24 connects to a wireless LAN and communicates with an external apparatus, using a method compliant with the Wi-Fi standard. Further, as a second communication form, the network communication section 24 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 communicate with each other directly or indirectly via an access point to transmit and receive data.

The main body apparatus 2 includes a controller communication section 25. The controller communication section 25 is connected to the processor 21. The controller communication section 25 wirelessly communicates with the left controller 3 and/or the right controller 4. The communication method between the main body apparatus 2 and the left controller 3 and the right controller 4 is optional. In the exemplary embodiment, the controller communication section 25 performs communication compliant with the Bluetooth (registered trademark) standard with the left controller 3 and with the right controller 4.

The processor 21 is connected to the left terminal 22 and the right terminal 23. When performing wired communication with the left controller 3, the processor 21 transmits data to the left controller 3 via the left terminal 22 and also receives operation data from the left controller 3 via the left terminal 22. Further, when performing wired communication with the right controller 4, the processor 21 transmits data to the right controller 4 via the right terminal 23 and also receives operation data from the right controller 4 via the right terminal 23. As described above, in the exemplary embodiment, the main body apparatus 2 can perform both wired communication and wireless communication with each of the left controller 3 and the right controller 4.

The main body apparatus 2 also includes a codec circuit 40, a speaker (specifically, a left speaker and a right speaker) 41, and an audio input/output terminal 42. The codec circuit 40 is connected to the speaker 41 and the audio input/output terminal 42 and also connected to the processor 21. The codec circuit 40 is a circuit that controls the input and output of audio data to and from the speaker 41 and the audio input/output terminal 42.

It should be noted that, in addition to the elements shown in FIG. 2, the main body apparatus 2 includes a battery that supplies power and an output terminal for outputting images and audio to an external display device (e.g., a television) separate from the display 12.

### Overview of Audio Control

Next, an overview of audio control performed by the game system 1 is described. For example, in the exemplary embodiment, a racing game is performed where a player object operated by a player runs on a field in a game space (an example of a virtual space). Audio control performed in the racing game according to the exemplary embodiment is described below.

In the exemplary embodiment, a sound source object as a virtual sound source is set in the virtual space. For example, the sound source object may be an object that moves in the virtual space, or may be an object fixed to the virtual space. The following description is given on the assumption that the sound source object moves in the virtual space.

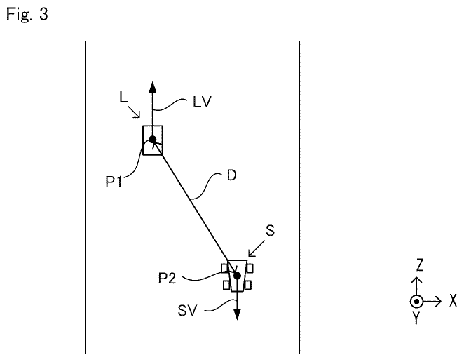

FIG. 3 is a diagram of a part of the virtual space during the racing game when viewed from above.

As shown in FIG. 3, a virtual listener L and a movable object S are placed in the virtual space. An XYZ orthogonal coordinate system is set in the virtual space. The Y-axis is an axis in an up direction in the virtual space, and the X-axis and the Z-axis are axes perpendicular to the Y-axis.

In the virtual space, the player object (not shown) that moves in the virtual space in accordance with an operation of the player is placed. The virtual listener L is an object set in accordance with the position of the player object and is a virtual microphone. During the racing game, a virtual camera is placed near the player object (e.g., behind the player object), and an image of the virtual space viewed from the virtual camera is displayed on a display device such as the display 12 or the like. The virtual listener L is set at the position of the virtual camera. The player moves the player object in the virtual space using the controllers while viewing the image based on the virtual camera. For example, if the A-button of the right controller 4 is pressed, the player object moves forward. If a direction operation input is provided to the analog stick 31 of the left controller 3, the moving direction of the player object changes. The virtual listener L moves in the virtual space in conjunction with the player object. For example, in FIG. 3, the virtual listener L is located at P1 and moving at a velocity LV (a velocity vector LV) in the virtual space.

For example, the movable object S is an object representing a virtual vehicle, a virtual motorcycle, or the like automatically controlled by the processor 21 and runs on the field. The movable object S is an object that does not participate in the racing game, and for example, runs in a direction opposite to the player object. For example, the movable object S may be an object as an obstacle to participating objects participating in the racing game that include the player object. The movable object S may be a participating object participating in the racing game and may be another player object controlled by another player. The movable object S may be a participating object participating in the racing game and may be a non-player object automatically controlled by the processor 21.

As shown in FIG. 3, the movable object S is located at P2 and running on the field at a velocity SV (a velocity vector SV) in the virtual space. The movable object S is an example of a sound source object that emits a sound. For example, the movable object S moves while continuously emitting a sound. The movable object S may intermittently emit a sound. In the virtual space, various sound source objects exist in addition to the movable object S. Each sound source object produces a sound according to the type of the sound source object.

In a memory (e.g., the flash memory 26 or a dedicated memory card) of the main body apparatus 2, audio data corresponding to the movable object S is stored in advance. A sound based on the audio data corresponding to the movable object S is controlled based on the positional relationship between the virtual listener L and the movable object S and output from a speaker (e.g., the speaker 41 of the main body apparatus 2, a speaker connected to the audio input/output terminal 42, or a speaker of an external display device).

Specifically, when a sound based on audio data is output, the sound volume of the sound based on the audio data is attenuated based on the distance between the virtual listener L and the movable object S. The attenuation of the sound volume according to the distance is referred to as “distance attenuation”.

In the exemplary embodiment, as the method for the attenuation of the sound volume according to the distance (the distance attenuation), any method may be used. For example, the distance attenuation may be performed based on an attenuation curve associating the distance with the sound volume. The distance attenuation may be performed based on a formula indicating the relationship between the distance and the sound volume. The manner of the distance attenuation of the sound volume may differ in accordance with the frequency of the sound. For example, a sound at a high frequency and a sound at a low frequency may differ in the attenuation of the sound volume according to the distance even if the distance is the same. The manner of the distance attenuation may also differ depending on the shape of the sound source.

In the calculation of conventional distance attenuation, the sound volume of a sound source is attenuated based on a distance D between a virtual listener and the sound source. Thus, for example, in a case where the virtual listener and the sound source pass each other at high speed, the distance between the virtual listener and the sound source becomes great in a short time, and the sound of the sound source instantly ceases to be heard. As a result, a player misses the sound from the sound source.

Accordingly, in the exemplary embodiment, on the premise that the distance attenuation is calculated using any method, the distance D between the virtual listener and the sound source is corrected, and the distance attenuation is calculated based on the corrected distance. Specifically, the distance D (the distance between P1 and P2 in the three-dimensional virtual space) is corrected so that the greater the velocity at which the virtual listener L and the movable object S go away from each other, the closer to the virtual listener L the movable object S is. Then, the distance attenuation for attenuating the sound volume of the sound from the movable object S is performed based on the corrected distance. Here, the corrected distance (the distance used to calculate the distance attenuation) is referred to as a “attenuation reference distance”. The method for calculating the attenuation reference distance is specifically described below.

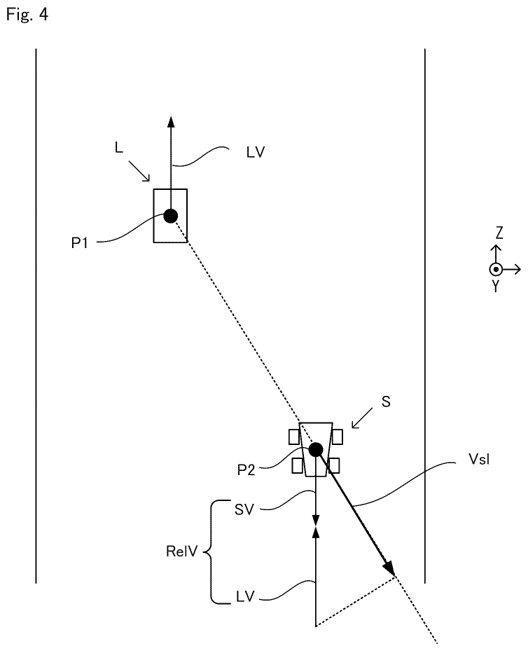

FIG. 4 is a diagram illustrating the method for calculating the attenuation reference distance.

As shown in FIG. 4, first, a relative velocity vector RelV is calculated based on the velocity vector LV of the virtual listener L and the velocity vector SV of the movable object S. The velocity vectors LV and SV have velocity components in the axis directions in the three-dimensional virtual space. Specifically, RelV is calculated based on the following formula (1).

$$RelV = SV - LV \qquad ( 1 )$$

Next, the velocity at which the movable object S goes away from the virtual listener L is calculated. Specifically, a vector SL from the position P1 of the virtual listener L to the position P2 of the movable object S in the virtual space is calculated, and a component Vsl in a direction along the vector SL of the relative velocity RelV is calculated. Specifically, Vsl is calculated based on the following formula (2).

$$Vsl = RelV \cdot NSL \qquad ( 2 )$$

Here, NSL is a unit vector of the vector SL. Vsl is the inner product of the vector RelV and the unit vector NSL. A vector LS from the position P2 of the movable object S to the position P1 of the virtual listener L may be calculated, and a component in a direction along the vector LS of the relative velocity RelV may be calculated.

Next, a correction value CV obtained by multiplying the calculated direction component Vsl by a coefficient Ratio set in advance is calculated. Specifically, the correction value CV is calculated based on the following formula (3).

$$CV = Vsl \times Ratio \qquad ( 3 )$$

If a value obtained by subtracting the correction value CV from the distance D between the virtual listener L and the movable object S is calculated as the attenuation reference distance, there is a case where the attenuation reference distance is too small. If the attenuation of the sound volume is calculated based on the calculated attenuation reference distance, and even when the sound source at a long distance that should not be heard goes away, the sound from the sound source can be heard by the player.

Accordingly, in the exemplary embodiment, the correction value CV is decreased at a decrease rate according to the distance D between the virtual listener L and the movable object S. For example, the decrease rate is calculated based on the following formula (4).

$$decrease rate = POWER ( COEF , - D ) \qquad ( 4 )$$

Here, “COEF” is a positive value set in advance. POWER(A, B) is a function that outputs A to the power of B.

Then, an attenuation reference distance CD is calculated by subtracting the correction value CV decreased at the decrease rate calculated using formula (4) from the distance D. Specifically, the attenuation reference distance CD is calculated based on the following formula (5).

$$CD = D - ( CV \times decrease rate ) \qquad ( 5 )$$

If the attenuation reference distance CD calculated using formula (5) is a negative value, CD is set to “0”.

Since the “decrease rate” becomes exponentially small in accordance with the distance D, if D is somewhat great, “CV×decrease rate” comes close to “0”. If the distance D is greater than or equal to a predetermined value, the decrease rate may be set to “0”. The above formula (4) is merely an example, and the decrease rate may be calculated using another formula so long as the greater the distance D is, the smaller the decrease rate is. The decrease rate may be calculated based on a graph indicating the relationship between the decrease rate and the distance D. The graph is a graph in which the greater the distance D is, the smaller the decrease rate is.

Then, the sound volume of the sound from the movable object S is attenuated based on the attenuation reference distance CD calculated by formula (5).

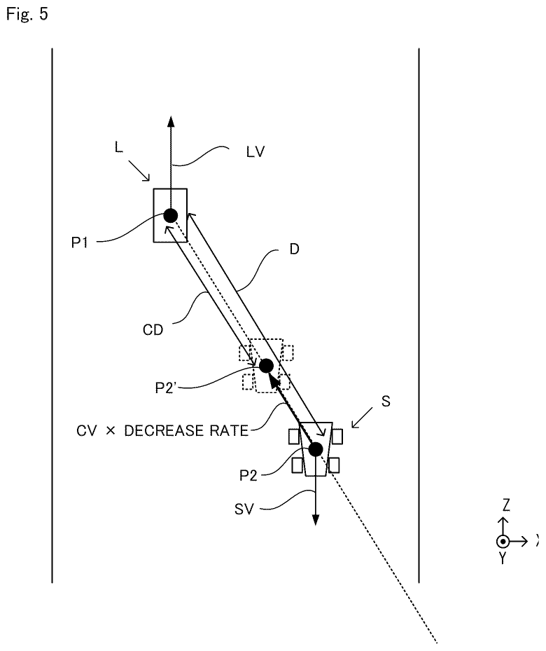

FIG. 5 is a diagram illustrating the distance attenuation based on the attenuation reference distance CD calculated by formula (5). As shown in FIG. 5, actually, the virtual listener L and the movable object S are the distance D away from each other, but the sound volume of the sound from the movable object S is attenuated as if the movable object S is present at a position P2′ close to the position P1 with “CV×decrease rate”. Thus, it is easy for the virtual listener (the player) at the position P1 to hear the sound from the movable object S.

In FIGS. 3 to 5, a case has been described where the movable object S that is the sound source moves in a direction opposite to the virtual listener L. In the virtual space, in addition to the movable object S, a plurality of sound source objects such as a sound source object that moves in any direction, a sound source object fixed to the virtual space, and the like are present.

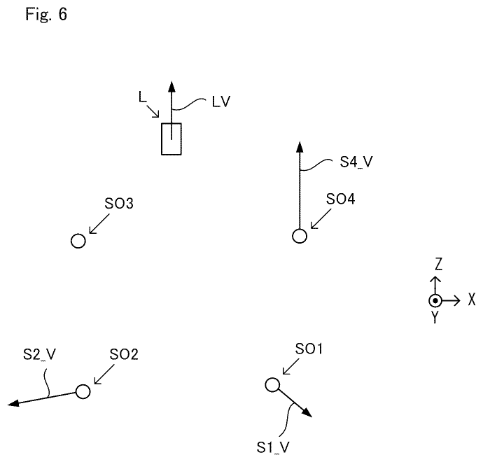

FIG. 6 is a diagram of the virtual space during the racing game when viewed from above and is a diagram showing an example of the virtual space in a case where a plurality of sound source objects exist.

As shown in FIG. 6, in the virtual space, the virtual listener L, a sound source object SO1, a sound source object SO2, a sound source object SO3, and a sound source object SO4 exist. These sound source objects are collectively referred to as “sound source objects S”.

The sound source object SO1 is moving at a velocity vector S1_V. The sound source object SO2 is moving at a velocity vector S2_V. The sound source objects SO1 and SO2 are moving in directions away from the virtual listener L. The sound source objects SO1 and SO2 may also be moving in a height direction (the Y-axis direction). The sound source object SO3 is at rest in the virtual space, but the virtual listener L is moving at the velocity vector LV, and therefore, the sound source object SO3 has a velocity at which the sound source object SO3 relatively goes away from the virtual listener L. Thus, regarding each of the sound source objects SO1 to SO3, the attenuation reference distance CD is calculated based on the above formula (5), and the distance attenuation of the sound volume of the sound source object is calculated based on the attenuation reference distance CD of the sound source object.

On the other hand, the sound source object SO4 is moving at a velocity vector S4_V and moving in the same direction as the virtual listener L. Specifically, the virtual listener L and the sound source object SO4 are moving in directions in which the virtual listener L and the sound source object SO4 relatively come close to each other. Thus, regarding the sound source object SO4, the attenuation reference distance CD is not calculated based on the above formula (5). In this case, the distance between the virtual listener L and the sound source object SO4 in the virtual space is set as the attenuation reference distance of the sound source object SO4. Then, the distance attenuation of the sound volume of the sound from the sound source object SO4 is calculated based on the set distance. The determination of whether or not the virtual listener L and the sound source object SO4 are coming close to each other may be made, for example, based on whether or not the inner product value of a relative velocity vector “S4_V-LV” between the virtual listener L and the sound source object SO4 is a positive value.

A sound source object is not limited to an object set in advance in the virtual space, and for example, may be an object that temporarily appears in the virtual space in accordance with an action of the player object or the game situation. A sound source object may be an object that is not displayed in a game image. For example, in a case where the player object jumps in the virtual space and lands on a particular terrain, the sound source object SO3 indicating a landing sound may temporarily appear at the landing position. Then, regarding the sound source object that has appeared at the landing position, the above attenuation reference distance CD may be calculated, and the distance attenuation of the sound volume of the sound source object may be calculated based on the attenuation reference distance CD.

As described above, in the exemplary embodiment, regarding at least one sound source set in the virtual space, if the virtual listener and the sound source go away from each other, the attenuation reference distance CD obtained by correcting the distance D between the virtual listener and the sound source so that the greater the velocity at which the sound source goes away from the virtual listener is, the closer to the virtual listener the sound source is calculated. Then, the distance attenuation of the sound from the sound source is calculated based on the attenuation reference distance CD. Then, a sound subjected to the distance attenuation is output from a speaker.

Thus, even in a case where a sound source goes away at high speed, it is possible to cause the player to hear the sound from the sound source to some extent, and it is possible to leave the presence of the sound source to some extent. For example, while the sound from a sound source object ceases to be heard in 0.5 seconds in a case where the above correction is not performed, the timing when the sound ceases to be heard is delayed by about 0.5 seconds in a case where the above correction is performed.

### Details of Audio Control Process

Next, the details of an audio control process performed by the game system 1 are described.

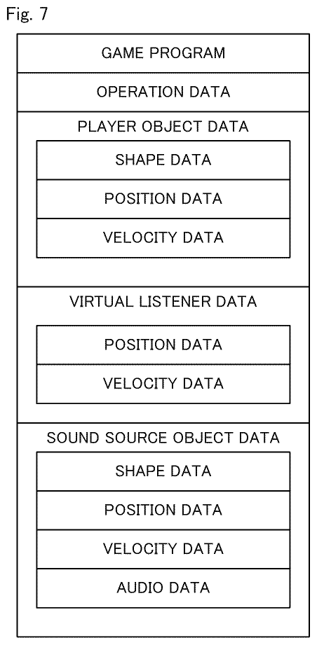

FIG. 7 is a diagram showing examples of various pieces of data stored in the game system 1. As shown in FIG. 7, a memory (e.g., the DRAM 27, a storage medium attached to the slot 29, or the flash memory 26) of the game system 1 stores a game program, operation data, player object data, virtual listener data, and sound source object data. In addition to these pieces of data, various pieces of data used in the racing game are stored.

The game program is a program for executing game processing according to the exemplary embodiment. The program includes a program for performing the above audio control. The game program is stored in advance in the storage medium attached to the slot 29 or the flash memory 26 and is loaded into the DRAM 27 when a game is executed.

For example, the operation data is data according to an operation of the player transmitted from the controllers 3 and 4. For example, the operation data includes data indicating the input amount according to the tilt of the left analog stick 31 in the left-right direction, data indicating whether or not each button is operated, and the like. The operation data is transmitted from the controllers to the main body apparatus 2 at predetermined time intervals (e.g., 1/200-second intervals).

The player object data is data regarding the player object controlled by the player. The player object data includes shape data indicating the shape and the external appearance of the player object, position data indicating the position in the three-dimensional virtual space of the player object, and velocity data indicating a velocity vector (the speed and the direction) of the player object.

The virtual listener data is data regarding the virtual listener L. The virtual listener data includes position data indicating the position P1 in the three-dimensional virtual space of the virtual listener L, and velocity data indicating the velocity vector LV (the speed and the direction) of the virtual listener L. The position P1 of the virtual listener L is set to the position of the virtual camera, and the velocity vector LV is set to a velocity vector of the virtual camera and the player object.

The sound source object data is data regarding the sound source objects S. The sound source object data is stored regarding each sound source object S. The sound source object data includes shape data indicating the shape and the external appearance of the sound source object S, position data indicating the position P2 in the three-dimensional virtual space of the sound source object S, and velocity data indicating the velocity vector SV (the speed and the direction) of the sound source object S. The sound source object data also includes audio data corresponding to the sound source object S. The sound source objects S may include an object that is automatically controlled by the processor 21 and does not participate in the racing game. The sound source objects S may include a participating object that participates in the racing game and is another player object operated by another player, or may include a non-player object automatically controlled by the processor 21. The sound source objects S may include an object fixed to the virtual space. The sound source objects S may include an object that is not displayed in a game image (an object that does not have shape data).

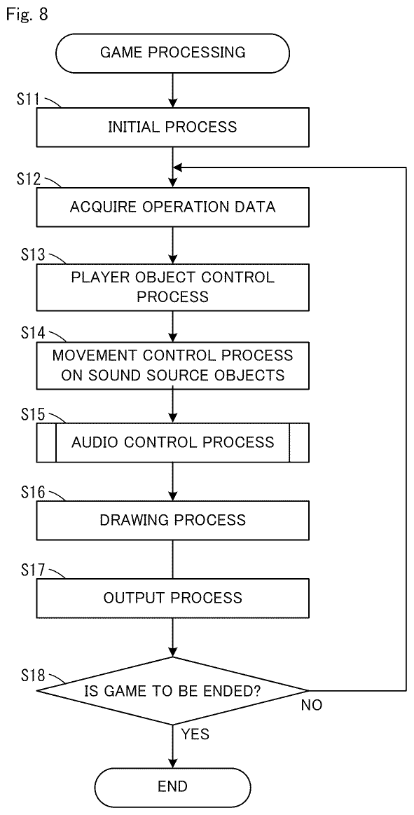

Next, game processing performed by the game system 1 is described. FIG. 8 is a flow chart showing an example of game processing regarding the racing game. The game processing is started if an instruction to start the racing game is given by the player. In FIG. 8, a process regarding the above audio control of the sound from the sound source is mainly described, and other processes are described in a simplified manner.

In the exemplary embodiment, the description is given on the assumption that the processes of steps shown in FIG. 8 are executed by the processor 21 of the main body apparatus 2 executing the game program using a memory. In another exemplary embodiment, however, some of the processes of the steps may be executed by a processor (e.g., a dedicated circuit or the like) different from the processor 21. In a case where the game system 1 can communicate with another information processing apparatus, some of the processes of the steps may be executed by another information processing apparatus. The processes of all of the steps are merely illustrative. Thus, the processing order of the steps may be changed, or another process may be performed in addition to (or instead of) the processes of all of the steps, so long as similar results are obtained.

As shown in FIG. 8, first, the processor 21 performs an initial process (step S11). Here, the processor 21 sets any one of a plurality of courses based on a selection operation of the player and starts the racing game. In the initial process, the player object, the virtual camera, the virtual listener L, and at least one sound source object S are set in the virtual space.

If the racing game is started, the processor 21 acquires operation data from the controllers 3 and 4 (step S12). From this point onward, the processor 21 repeatedly executes the processes of steps S12 to S18 at predetermined frame time intervals (e.g., 1/60-second intervals).

Next, the processor 21 executes a player object control process (step S13). Here, based on the operation data, the processor 21 updates the position, the orientation, the velocity vector, and the like of the player object. For example, the processor 21 updates the speed of the player object in accordance with whether or not an accelerator operation is performed, updates the moving direction of the player object in accordance with the input amount according to the tilt in the left-right direction of the left analog stick 31, and updates the position of the player object based on the updated speed and moving direction (velocity vector). The processor 21 also sets the positions of the virtual camera and the virtual listener L based on the position of the player object. For example, the positions of the virtual camera and the virtual listener L are set to positions a predetermined distance away from the player object. The processor 21 also sets the velocity vector LV of the virtual listener L to the velocity vector of the player object.

Next, the processor 21 performs a movement control process on the sound source objects S (step S14). Here, the processor 21 performs movement control of the sound source objects S in the virtual space. Specifically, the processor 21 updates the velocity vector SV of each sound source object S and also updates the position P2 of the sound source object S. For example, the processor 21 updates the velocity vector of the movable object S that does not participate in the racing game in accordance with a predetermined algorithm, and updates the position of the movable object S. The processor 21 also updates a velocity vector of a non-player object that participates in the racing game and is a sound source in accordance with a predetermined algorithm, and updates the position of the non-player object.

The main body apparatus 2 according to the exemplary embodiment can execute the racing game in a multiplay mode based on communication with another main body apparatus 2. In a case where the racing game is performed in the multiplay mode, in step S14, the processor 21 receives game data from another main body apparatus 2 and performs movement control of another player object that corresponds to the other main body apparatus 2 and is a sound source based on the game data.

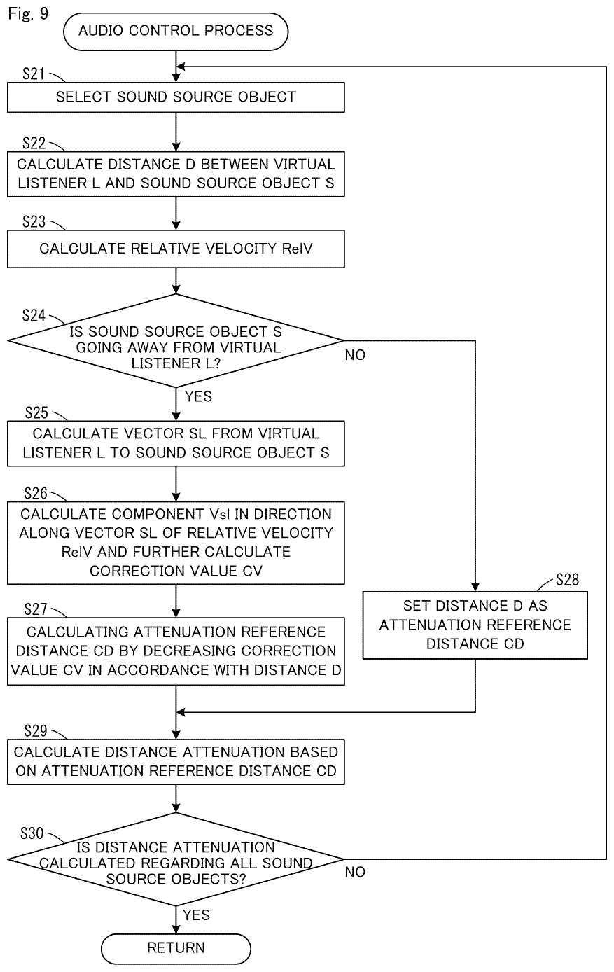

Next, the processor 21 performs an audio control process (step S15). Here, the sound from a sound source object S set in the virtual space is controlled. The details of the audio control process in step S15 are described below. FIG. 9 is a flow chart showing the details of the audio control process in step S15.

As shown in FIG. 9, the processor 21 selects a single sound source objects S set in the virtual space (step S21). Here, the processor 21 selects a sound source object S regarding which the distance attenuation has not yet been calculated among the plurality of sound source objects present in the virtual space. In step S21, only a sound source object of which the distance from the virtual listener L is less than a threshold may be selected. In this case, the distance attenuation may not be calculated regarding the sound from a sound source object of which the distance from the virtual listener L is greater than or equal to the threshold, and the sound from the sound source object may not be output from a speaker.

Next, the processor 21 calculates the distance D in the virtual space between the virtual listener L and the sound source object S (step S22).

Next, the processor 21 calculates the relative velocity RelV between the virtual listener L and the sound source object S (step S23). Specifically, the processor 21 calculates the relative velocity vector RelV by subtracting the velocity vector LV of the virtual listener L from the velocity vector SV of the sound source object S.

Next, the processor 21 determines whether or not the sound source object S is going away from the virtual listener L (step S24). For example, based on whether or not the inner product of the relative velocity vector RelV and the velocity vector LV is negative, the processor 21 may determine whether or not the sound source object S is going away from the virtual listener L.

If the sound source object S is going away from the virtual listener L (step S24: YES), the processor 21 calculates the vector SL from the position P1 of the virtual listener L to the position P2 of the sound source object S (step S25).

Next, the processor 21 calculates the component Vsl in the direction along the vector SL of the relative velocity RelV and further calculates the correction value CV (step S26). Specifically, the processor 21 calculates the unit vector NSL of the vector SL and calculates the inner product Vsl of the relative velocity vector RelV and the unit vector NSL. Then, the processor 21 calculates the correction value CV by multiplying Vsl by the coefficient Ratio set in advance.

Next, the processor 21 calculates the attenuation reference distance CD by decreasing the correction value CV in accordance with the distance D (step S27). Specifically, for example, based on the above formula (4), the processor 21 calculates the “decrease rate” that decreases in accordance with the distance D. Then, the processor 21 calculates a value obtained by subtracting “CV×decrease rate” from the distance D as the attenuation reference distance CD.

If, on the other hand, the sound source object S is not going away from the virtual listener L (step S24: NO), the processor 21 sets the distance D between the virtual listener L and the sound source object S as the attenuation reference distance CD (step S28).

If the process of step S27 is performed, or if the process of step S28 is performed, the processor 21 calculates the distance attenuation of the sound volume of the sound source object S based on the attenuation reference distance CD (step S29). As the method for the distance attenuation, any method may be used.

Next, the processor 21 determines whether or not the distance attenuation is calculated regarding all the sound source objects (step S30). For example, the processor 21 determines whether or not the distance attenuation is calculated regarding all the sound source objects existing within a predetermined distance from the virtual listener L. The processor 21 may determine whether or not the distance attenuation is calculated regarding all the sound source objects existing in the virtual space.

If the determination is NO in step S30, the processor 21 executes the process of step S21 again. If the determination is YES in step S30, the processor 21 ends the process shown in FIG. 9, and the processing returns to FIG. 8.

Referring back to FIG. 8, after the audio control process in step S15, the processor 21 performs a drawing process (step S16). Here, the processor 21 generates a game image based on the virtual camera.

Next, the processor 21 performs an output process (step S17). Here, the processor 21 outputs the game image generated in step S16 and also outputs a sound based on the result of the audio control process in step S15. Consequently, the game image is displayed on a display device (the display 12 or an external display device), and the sound from each sound source object is output from a speaker.

Next, the processor 21 determines whether or not to end the racing game (step S18). For example, based on whether or not the player object reaches a goal set on the course, the processor 21 determines whether or not to end the racing game. If the determination is YES in step S18, the processor 21 ends the processing shown in FIG. 8. If the determination is NO in step S18, the processor 21 executes the process of step S12 again.

As described above, in the exemplary embodiment, if the sound source object S is going away from the virtual listener L (step S24: YES), the attenuation reference distance CD obtained by correcting the distance D between the sound source object S and the virtual listener L (CV×decrease rate) so that the greater the velocity at which the sound source object S and the virtual listener L go away distant from each other is, the closer to the virtual listener L the sound source object S is calculated (step S27). Then, the distance attenuation of the sound volume of the sound from the sound source object S is calculated based on the attenuation reference distance CD (step S29).

Consequently, for example, even if the sound source object S goes away from the virtual listener L at high speed, it is possible to output the sound from the sound source object S, and it is possible to leave the presence of the sound source object to some extent.

### Variations

While the exemplary embodiment has been described above, the exemplary embodiment is merely an example and may be modified as follows, for example.

For example, the formulas used in the above exemplary embodiment are merely examples, and may be replaced by other formulas.

In the above exemplary embodiment, on the premise that the virtual listener L is moving at the velocity vector LV, the relative velocity with the sound source object S is calculated, and the attenuation reference distance CD is calculated based on the relative velocity. Even when the virtual listener L is at rest, the relative velocity with the sound source object S is calculated, and the attenuation reference distance CD is calculated based on the relative velocity.

In the above exemplary embodiment, the position of the virtual listener L is set to a position according to the position of the player object (e.g., the position of the virtual camera a predetermined distance away from the player object). In another exemplary embodiment, the position of the virtual listener may be set to the position of the player object. For example, the position of the virtual listener may be set to the center of the player object, or may be set to a predetermined position on the surface of the player object.

In the above exemplary embodiment, on the premise that a racing game is performed where a player object moves in a virtual space, audio control of a sound source object in the racing game is described. In another exemplary embodiment, the above audio control may be used not only in a racing game, but also in any game. For example, the above audio control may be used in a game where a sound source object and a player object freely move in a three-dimensional virtual space, a shooting game, a role-playing game, a fighting game, or the like. The above audio control may be used not only in a game, but also in audio control of any virtual sound source set in a virtual space.

The above audio control process may be executed not only by the game system 1, but also by any other information processing apparatus or information processing system. For example, the information processing apparatus may be a smartphone, a tablet terminal, a personal computer, a game apparatus, a server, or the like. The information processing system may be formed of a plurality of apparatuses, and the plurality of apparatuses may be connected together via a network (e.g., a LAN, the Internet, or the like).

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to perform operations comprising:
regarding each of at least one sound source set in a virtual space,
based on an attenuation reference distance obtained by correcting a distance between a position of a virtual listener and a position of the sound source in the virtual space so that the greater a velocity at which the sound source goes away from the virtual listener is, the closer to the virtual listener the sound source is,
based on distance attenuation according to the attenuation reference distance, determining a sound volume of audio set for the sound source; and
based on the determined sound volume, outputting the audio set for the sound source.

2. The one or more non-transitory computer-readable storage media according to claim 1, wherein
the velocity at which the sound source goes away from the virtual listener is a value based on a component in a direction from the sound source to the virtual listener or a component in a direction from the virtual listener to the sound source of a relative velocity between the sound source and the virtual listener.

3. The one or more non-transitory computer-readable storage media according to claim 1, wherein
the operations further comprise
making the correction so that the greater the distance between the position of the virtual listener and the position of the sound source in the virtual space is, the smaller the correction is.

4. The one or more non-transitory computer-readable storage media according to claim 1, wherein
the virtual listener is set at a position according to a position of a virtual camera in the virtual space.

5. The one or more non-transitory computer-readable storage media according to claim 4, wherein
the operations further comprise:
performing movement control of a player object in the virtual space based on an operation input; and
performing movement control of the position of the virtual camera so that the position of the virtual camera is a position according to a position of the player object.

6. The one or more non-transitory computer-readable storage media according to claim 5, wherein
the player object is a running object that runs on a field in the virtual space,
the sound source is at least set at a position of the running object other than the player object in the virtual space, and
the operations further comprise
causing the player object and the running object other than the player object to run on the field.

7. An information processing system comprising:
one or more processors; and
one or more non-transitory computer-readable media storing instructions that, when executed, cause the one or more processors to perform operations comprising:
regarding each of at least one sound source set in a virtual space,
based on an attenuation reference distance obtained by correcting a distance between a position of a virtual listener and a position of the sound source in the virtual space so that the greater a velocity at which the sound source goes away from the virtual listener is, the closer to the virtual listener the sound source is,
based on distance attenuation according to the attenuation reference distance, determining a sound volume of audio set for the sound source; and
based on the determined sound volume, outputting the audio set for the sound source.

8. The information processing system according to claim 7, wherein
the velocity at which the sound source goes away from the virtual listener is a value based on a component in a direction from the sound source to the virtual listener or a component in a direction from the virtual listener to the sound source of a relative velocity between the sound source and the virtual listener.

9. The information processing system according to claim 7, wherein
the operations further comprise
making the correction so that the greater the distance between the position of the virtual listener and the position of the sound source in the virtual space is, the smaller the correction is.

10. The information processing system according to claim 7, wherein
the virtual listener is set at a position according to a position of a virtual camera in the virtual space.

11. The information processing system according to claim 10, wherein
the operations further comprise:
performing movement control of a player object in the virtual space based on an operation input; and
performing movement control of the position of the virtual camera so that the position of the virtual camera is a position according to a position of the player object.

12. The information processing system according to claim 11, wherein
the player object is a running object that runs on a field in the virtual space,
the sound source is at least set at a position of the running object other than the player object in the virtual space, and
the operations further comprise
causing the player object and the running object other than the player object to run on the field.

13. A computer-implemented method comprising:
regarding each of at least one sound source set in a virtual space,
based on an attenuation reference distance obtained by correcting a distance between a position of a virtual listener and a position of the sound source in the virtual space so that the greater a velocity at which the sound source goes away from the virtual listener is, the closer to the virtual listener the sound source is,
based on distance attenuation according to the attenuation reference distance, determining a sound volume of audio set for the sound source; and
based on the determined sound volume, outputting the audio set for the sound source.

14. The computer-implemented method according to claim 13, wherein
the velocity at which the sound source goes away from the virtual listener is a value based on a component in a direction from the sound source to the virtual listener or a component in a direction from the virtual listener to the sound source of a relative velocity between the sound source and the virtual listener.

15. The computer-implemented method according to claim 13, further comprising
making the correction so that the greater the distance between the position of the virtual listener and the position of the sound source in the virtual space is, the smaller the correction is.

16. The computer-implemented method according to claim 13, wherein
the virtual listener is set at a position according to a position of a virtual camera in the virtual space.

17. The computer-implemented method according to claim 16, further comprising:
performing movement control of a player object in the virtual space based on an operation input; and
performing movement control of the position of the virtual camera so that the position of the virtual camera is a position according to a position of the player object.

18. The computer-implemented method according to claim 17, wherein
the player object is a running object that runs on a field in the virtual space,
the sound source is at least set at a position of the running object other than the player object in the virtual space, and
the computer-implemented method further comprises
causing the player object and the running object other than the player object to run on the field.
